(19) United States
(12) Patent Application Publication
(10) Pub. No.: US 2008/0184898 A1
(43) Pub. Date: Aug. 7, 2008

(54) Angled conveyor for return toaster

(75) Inventors: Ming Lung Huang, Fort Wayne, IN (US); Vincent Anthony Maranto, Fort Wayne, IN (US)

Correspondence Address: Paul D. Greeley;Ohlandt, Greeley, Ruggiero & Perle, L.L.P., 10th Floor, One Landmark Square, Stamford, CT, 06901-2682, US

(73) Assignee: MERCO/SAVORY, LLC.

(21) Appl. No.: 12/001,015

(22) Filed: Dec. 7, 2007

Related U.S. Application Data
(60) Provisional application No. 60/869,041, filed on Dec. 7, 2006.

(51) Int. Cl. A47J 37/08

(52) U.S. Cl. 99/386

(57) ABSTRACT

A conveyorized return toaster for toasting food products has an inclined angled conveyor for conveying the food products from a lower point outside the toaster to a higher point in the toaster. The inclined angle is at a degree sufficient to cause the center of gravity of the food product to shift rearward from where it would be on a horizontal conveyor and allow the product to extend at a length further beyond the back end of the inclined conveyor than if the conveyor were horizontally disposed. This increases the rotational moment of the food product over the back end of the conveyor and increases the subsequent food product exit force to propel the food product completely to the front opening of the toaster.

### CROSS REFERENCE TO RELATED APPLICATION

This application is based on and claims the benefit of Provisional Application Ser. No. 60/869,041, filed Dec. 7, 2006.

### BACKGROUND OF THE INVENTION

1. Field of the Invention

The present disclosure relates generally to conveyorized toasters for food products. The toasters generally have a front opening which allows the user to place the food product on the front end of the conveyor. The conveyor is horizontally disposed and transports the food product inside the toaster, past heaters and then drops the product off the conveyor at its back end for return to the front opening via a return chute comprised of mostly downwardly angled surfaces. More particularly, the present disclosure relates to such toasters whose conveyors are advantageously disposed at an inclined angle.

2. Discussion of the Background Art

Conventional conveyorized toasters that employ a horizontally disposed conveyor have been found by the present inventors to cause the toasted food products to sometimes get stuck and accumulate between the back end of the conveyor and the adjacent walls of the return chute of the toaster, there resulting in potential fire hazards.

One option to solve this potential fire hazard problem would be to substantially increase the space between the end of the conveyor belt and the adjacent surfaces of the return chute. Unfortunately, this would result in a toaster footprint which would be too large, for example, too high and/or too long or deep for commercial kitchens and food service areas.

Conventional toaster configurations with horizontally disposed conveyors heretofore have required the application of additional forced air into the toaster to force hot air created during toasting to the vented back portion of the toaster. Providing this forced air is not-economical. It uses energy and increases the cost of the toaster to the manufacturer and consumer.

Another disadvantage of conventional conveyorized toasters is the amount of exposure toaster operators have to infrared energy at the front opening of the toaster.

### SUMMARY OF THE DISCLOSURE

It is an object of the present disclosure to overcome the aforementioned and other problems and disadvantages of conventional conveyorized toasters.

Another object of this disclosure is to provide a conveyorized toaster that eliminates the potential fire hazard of toasted food products becoming lodged and accumulating between the back end of conveyors and adjacent surfaces of return chutes.

Another object of this disclosure is to provide a conveyorized toaster that prevents the aforementioned fire hazards, yet has an acceptable footprint for commercial kitchens and food service areas.

Another object of this disclosure is to provide a conveyorized toaster that ensures return of all toasted food products to the front opening of the toaster.

Another object of this disclosure is to provide a conveyorized toaster whose conveyor is disposed at an inclined angle from the front opening into the oven chamber of the toaster.

Another object of this disclosure is to provide a conveyorized toaster whose inclined angle conveyor increases the effective return space for a given toaster footprint.

Another object of this disclosure is to provide a conveyorized toaster whose inclined conveyor and return chute cause toasted food products leaving the conveyor to flip over and be propelled with enough exit force to ensure their full return, without jamming, to the front opening of the toaster.

It provides a conveyorized toaster whose conveyor is disposed at an inclined angle from the front opening into the oven chamber of the toaster, the inclined angle being at a degree sufficient to cause the center of gravity of the food product on the conveyor to shift rearward and allow the food product to extend at a length further beyond the back end of the inclined conveyor than if the conveyor were horizontally disposed.

Yet another object of this disclosure is to provide a conveyorized toaster that does not require additional forced air to force heated air in the toaster to the rear of the toaster for venting.

Still another object of the disclosure is to provide a conveyorized toaster whose inclined angle conveyor creates a natural chimney effect that directs heated air in the toaster to the back end of the toaster for venting, and thereby keeps the operating area of the toaster cool to the user.

Still another object of the disclosure is to utilize the inclined angle conveyor to block infra red energy from reaching operators of the toaster.

These and other objects and advantages of the present disclosure are provided by a food toaster comprising: a housing defining a front opening, and, communicating with the front opening, an interior oven chamber, at least one heater mounted to the housing in the oven chamber to heat food products when they are in the oven chamber, and a conveyor mounted to the housing and extending at an inclined angle from the front opening into the oven chamber, for conveying one or more food products on the conveyor into the oven chamber.

The inclined conveyor has a back end in the oven chamber, and the inclined angle is at a degree sufficient to cause the center of gravity of the food product on the conveyor to shift rearward and allow the food product to extend at a length further beyond the back end of the inclined conveyor than if the conveyor were horizontally disposed.

The inclined conveyor increases the rotational moment of the food product over the back end of the conveyor and increases the subsequent food product exit force to propel the food product completely to the front opening of the housing, thereby to avoid a logjam of food products adjacent the front end of the return chute.

The additional length that the leading portion of the food product extends beyond the back end of the inclined conveyor causes the leading portion of the food product to pivot about the back end of the conveyor and the food product to flip over and land on its top surface on the return chute for passage to the front opening of the housing.

The incline of the angle of the conveyor can be any suitable angle. For example, it can be from about 5 degrees to about 12 degrees, preferably from about 6 degrees to about 8 degrees, and more preferably about 7 degrees, from the horizontal.

The front opening of the housing can be defined in part by a lower lip, and there can be included a food collector tray that extends forward away from the lower lip to receive food products that exit the front opening and prevent an accumulation of food products on the return chute just inside of the front opening.

Further objects, features and advantages of the present disclosure will be understood by reference to the following drawings and detailed description.

### BRIEF DESCRIPTION OF THE DRAWINGS

FIG. 1 is a front right side perspective view of a conventional, prior art, conveyorized toaster having a horizontally disposed conveyor;

FIG. 2 is a vertical cross-sectional view, with portions broken away, as would be seen along line 2-2 of FIG. 1;

FIG. 3 is a top front perspective view of an embodiment of an improved toaster having an inclined angled conveyor according to the present disclosure;

FIG. 3A is a vertical cross-sectional view, with portions broken away, as would be seen along line 3A-3A through the conveyorized toaster of FIG. 3 having an angled conveyor according to the present disclosure;

FIG. 4 is a vertical cross sectional view, with portions broken away, of a conventional prior art conveyorized toaster with a horizontally disposed conveyor similar to that shown in FIG. 2, and schematically showing a food product stuck in the food product return chute;

FIG. 5 is a vertical cross sectional view, with portions broken away, of a conveyorized toaster similar to that shown in FIG. 3A having an angled conveyor according to the present disclosure, and schematically showing a food product freely moving from the conveyor through the return chute without getting stuck therein; and

FIG. 6 is a schematic depicting the increased food product travel length beyond the back edge of the conveyor that is provided by the inclined angle conveyor of the present disclosure.

### DETAILED DESCRIPTION OF THE PREFERRED EMBODIMENT

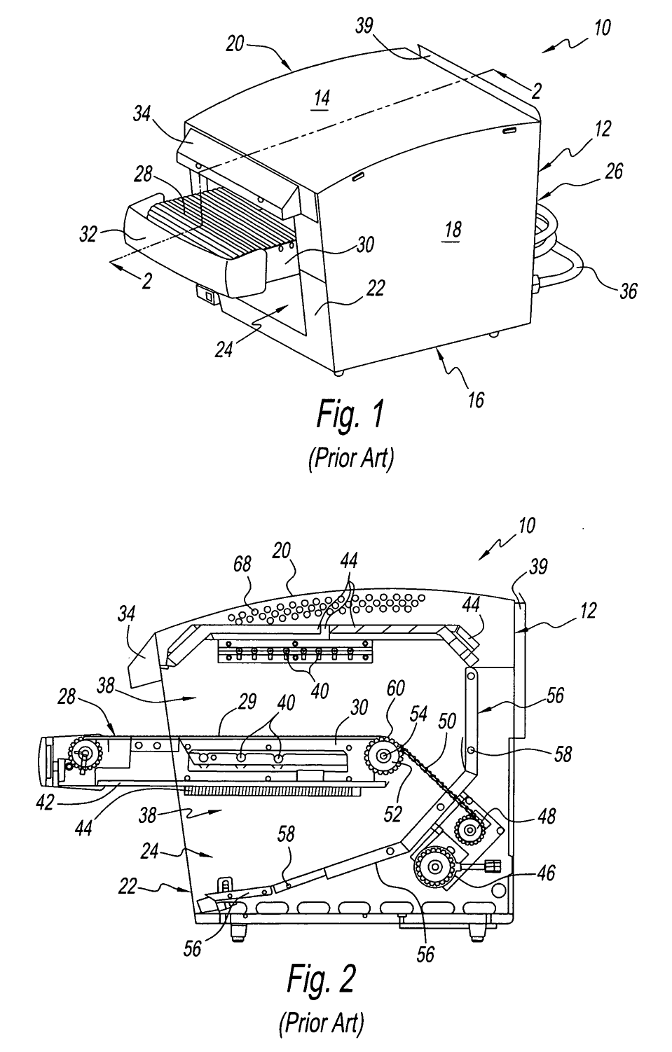

Referring to FIG. 1, there is shown a conventional prior art food toaster 10, comprised of a housing 12 having a top wall 14, a bottom wall 16, a right side wall 18, a left side wall 20, a front wall 22 that defines a front opening 24, and a rear wall 26. A horizontally disposed conveyor 28 is mounted to a structural frame 30 that is in turn mounted to housing 12 by suitable means (not shown). The front end of conveyor 28 is protected from a user by a wrap around shield 32. Front wall 22 includes an attached hood 34, and a control panel (not shown) that is connected to a power cord 36. Rear wall 26 includes a vent 39 for venting hot air from housing 12.

FIG. 2 is a side view of the conventional prior art food toaster 10, with portions in section and portions removed, as would be seen along vertical sectional line 2-2 of FIG. 1. More particularly, FIG. 2 shows that toaster 10 is comprised of housing 12 whose front wall 22 defines front opening 24 that communicates with an interior oven chamber 38. Conveyor 28 extends from outside of front opening 24 horizontally into a rear portion of oven chamber 38, for conveying one or more food products (not shown) into oven chamber 38 under and past at least one heater 40, here shown as a plurality of, for example, eight conventional elongated tubular sheathed heater elements or rods 40. Heater rods 40 are disposed orthogonally to the direction of travel of belt 29 of conveyor 28. One or more, preferably a plurality, e.g., three, heater rods 40 are located between the upper incoming portion of conveyor belt 29 and the underlying return portion of the belt (not shown). The number, location and disposition of heaters 40 can vary, depending for example on the type of food product.

A removable crum collector tray 42 extends under the return portion of conveyor belt 29. One or more, here shown as two layers of insulation 44 are mounted to housing 12 above upper heaters 40 to keep the housing cool to the touch. A layer of insulation 44 can also be provided under crum collector tray 42. FIG. 2 shows air vent holes 68 in the upper portion of left side

Belt 29 of conveyor 28 is conventionally rotationally driven at its distal or back end by a conventional conveyor gear motor 46. Gear motor 46 drives a sprocket wheel 48 which drives a sprocket chain 50 that engages a sprocket wheel 52 fixed to a shaft 54. Belt 29 is connected to and driven by sprocket wheel 52. The return portions of sprocket chain 50 and of belt 29 are not shown.

Oven chamber 38 includes a food product return chute 56 that is mounted to housing 12 by suitable fasteners 58. Return chute 56 extends from an interior portion of oven chamber 38 adjacent to but beyond back end 60 of the conveyor to front opening 24. Return chute 56 is configured to receive food products that drop off of back end 60 of the conveyor and return the received food products to front opening 24 of housing 12. Return chute 56 need not be, but preferably is comprised of a single sheet of shaped stainless steel metal.

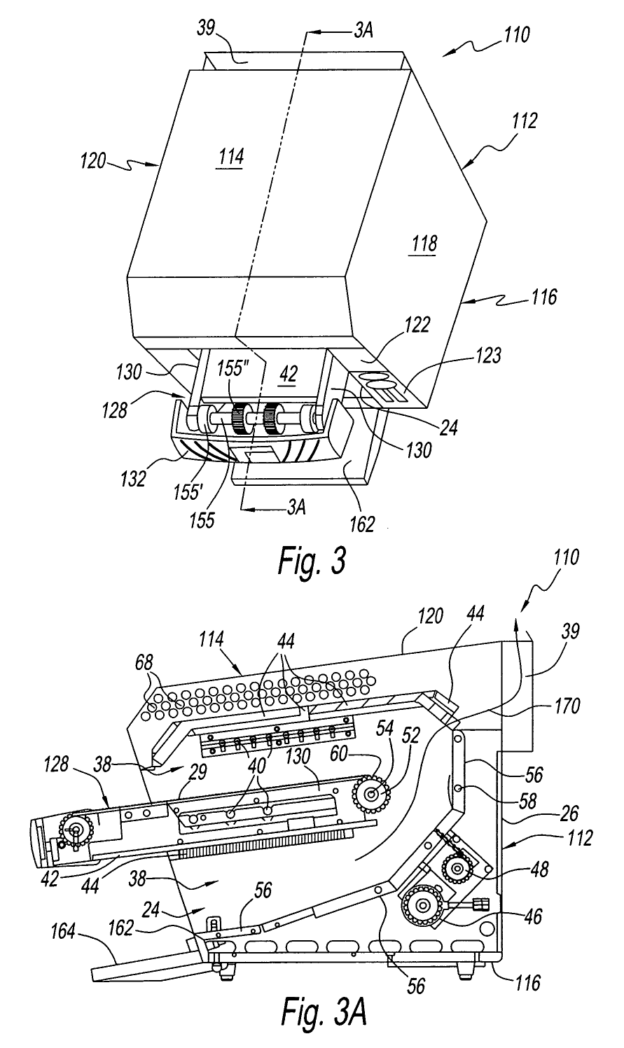

FIG. 3 is a top front perspective view of an improved conveyorized food toaster 110 having an inclined angled conveyor 128 whose belt is removed, thereby exposing crum collector tray 42. FIG. 3 shows a conveyor structural frame 130 having mounted to its proximal end a shaft 155 on which are mounted smooth surfaced guide rollers 155′ and textured or friction surfaced rollers 155″ for supporting and guiding belt 29, (not shown).

FIG. 3 shows that front opening 24 of housing 112 is defined in part by a lower lip 162, and there is included a food collector tray 164 that extends forward away from the lower lip 162 to receive food products that exit front opening 24 and prevent food products from accumulating on return chute 56 just inside of front opening 24.

FIG. 3A is a vertical sectional view, with portions in section and portions removed, of an embodiment of the improved food toaster 110 having an angled conveyor according to the present disclosure, as would be seen along line 3A-3A of FIG. 3. More particularly, FIG. 3A shows that conveyor 128 is disposed at an inclined angle from a lower point in front of, or from front opening 24 of food toaster 110, to a higher point inside oven chamber 38. The back end of food conveyor 128 preferably is located toward the back end of oven chamber 38. The inclined angle can be any suitable angle, depending, for example, on the shape, size and type of food product that is to be toasted. In general, the inclined angle of food conveyor 128 need not be, but can be from about 5 degrees to about 12 degrees, more preferably from about 6 degrees to about 8 degrees, and most preferably about 7 degrees, from the horizontal. FIG. 3A shows conveyor 128 inclined at an angle of 7 degrees. FIG. 3A also shows the path 170 of hot air provided by the chimney effect resulting from the use of the inclined angle conveyor of the present disclosure.

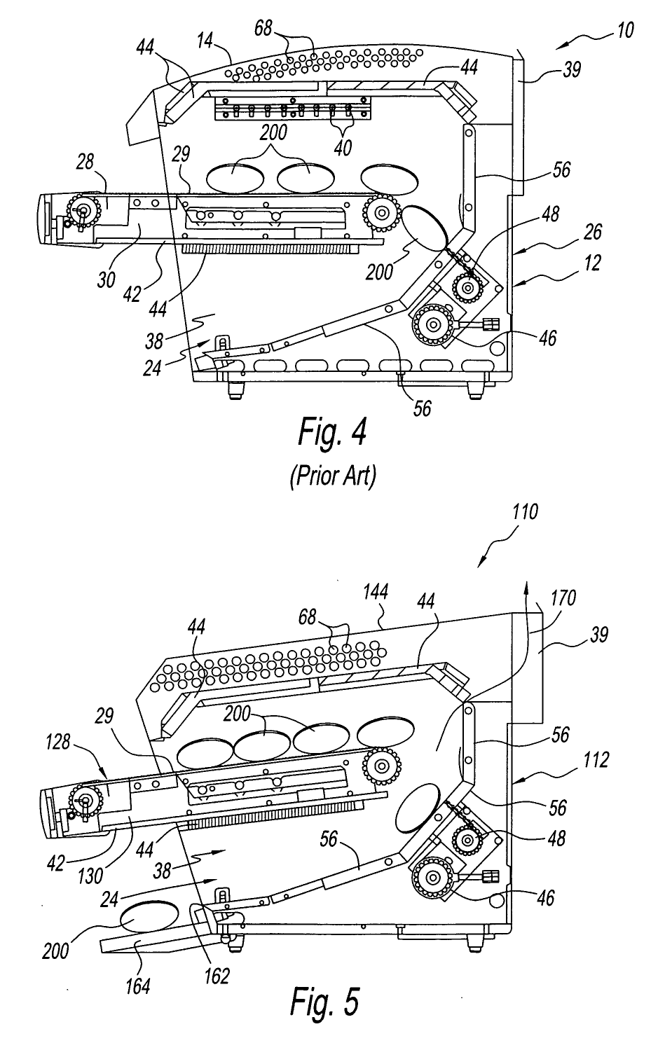

FIG. 4 is a vertical cross sectional view of a conventional prior art food toaster 10 having a horizontally disposed conveyor 28 similar to that shown in FIG. 2. FIG. 4 schematically shows a plurality of food products 200 on conveyor belt 29 and being moved further into oven chamber 38. FIG. 4 shows one of the problems that arises from use of the prior art horizontally disposed conveyors 28, namely, that one or more food products 200 can become lodged and stuck between a rear portion of food conveyor 28, for example, sprocket wheel 52 and an adjacent portion of return chute 56. The lodged food product(s) can cause a back-up or logjam of food products, which interrupts the flow of toasted food products from the toaster. The lodged food products can become overheated and cause a fire. Further, removing the lodged food product can be dangerous to the operator.

FIG. 4 shows that the food product that is on the back end of belt 29 and that is about to drop off, is tipped and balanced on its center of gravity, one half the length of the food product being forward of and the other one-half rearward of the center of gravity point of balance.

FIG. 5 is a vertical cross sectional view of a toaster 110 having an angled conveyor 128 according to the present disclosure and schematically showing food products 200 freely moving from conveyor 128 to and through return chute 56 without getting stuck in oven chamber 38. In FIGS. 4 and 5, the top surfaces of food products 200 are shown with a heavy or bold line to show that in FIG. 5, if a sufficient angle of inclination is chosen, the leading portion of food product 200 will travel further off of the back end of conveyor 128, will be heavier, will tip downward further, i. e., at a greater angle, and will flip over onto what was its top surface as it is being propelled from belt 29.

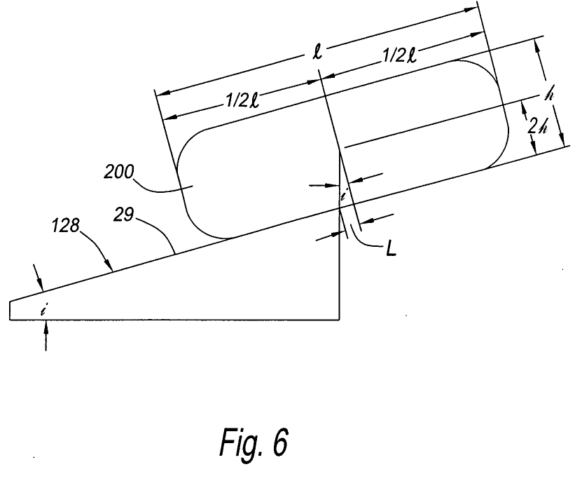

FIG. 5 shows that the food product 200 that is on the back end of belt 29 is in a state of imbalance, with more than one half the length of the food product being forward of the point of contact with conveyor belt 29, and less than one half the length of the food product being rearward of the point of contact with conveyor belt 29. As will be explained in connection with FIG. 6, food conveyor 128 of FIG. 5 is disposed at an inclined angle that is at a degree sufficient to cause the center of gravity of food product 200 on belt 29 of conveyor 128 to shift rearward and allow the food product to extend at a length further beyond the back end of the inclined conveyor than if the conveyor were horizontally disposed.

FIG. 6 is a schematic depicting the increased food product travel length L beyond the back edge of the conveyor that is provided by inclined angle conveyor 128 of the present disclosure. More particularly, FIG. 6 identifies and explains the variables of the equation L=½h·tan i. The equation can be used to determine, for a particular food product, and for a selected angle of inclination (i) of a conveyor, the distance the center of gravity of the food product will shift rearward and the additional distance or length L the leading portion of the food product will extend beyond the point of contact between the food product and belt 29 before the center of gravity passes the back edge of conveyor 128 and causes the food product to fall or be propelled from conveyor 128. The angle of inclination of conveyor 128 will cause, and the position of return chute 56 relative to the back end of conveyor 128 will allow toasted food products 200 leaving conveyor 128 to not only flip over, but also be propelled with enough exit force to ensure their full return, without jamming, to front opening 24, and to a food collection tray 164, if one is employed. It has been found that the aforementioned flipping over and full return for given food products can be achieved with less return chute space than, or the same chute space as employed in the prior art and that caused jamming in toaster 10. Thus, the embodiment of food toaster 110 described in the present disclosure that employs an inclined conveyor 128, increases the effective return space for a given toaster footprint.

The inclined angle toaster of the present disclosure achieves the objectives of the disclosure. The inclined conveyor provides 100% surety that the toasted food products will flip and return to the front opening of the toaster without burning of getting trapped in the return chute. The inclined angle toaster eliminates the potential fire hazard of toasted food products becoming lodged and accumulating between the back end of conveyors and adjacent surfaces of return chutes. It does this while retaining an acceptable footprint for commercial kitchens and food service areas. It provides a conveyorized toaster that ensures return of all toasted food products to the front opening of the toaster. It provides a conveyorized toaster whose conveyor is disposed at an inclined angle from the front opening into the oven chamber of the toaster, the inclined angle being at a degree sufficient to cause the center of gravity of the food product on the conveyor to shift rearward and allow the food product to extend at a length further beyond the back end of the inclined conveyor than if the conveyor were horizontally disposed.

The inclined angle toaster of the present disclosure additionally provides a conveyorized toaster that does not require additional forced air to force heated air in the toaster to the rear of the toaster for venting. It provides a conveyorized toaster whose inclined angle conveyor creates a natural chimney effect that directs heated air in the toaster to the back end of the toaster for venting, and thereby keeps the operating area of the toaster cool to the user. It utilizes the inclined angle conveyor to block some infra red energy from reaching operators of the toaster.

The inclined angle conveyorized toaster of the present disclosure can be employed to toast the same or a greater variety of food products as those toasted on prior art toasters that employ a horizontally disposed conveyor, for example and without limitation, bagels, variously shaped buns, e. g., hot dog buns, hamburger buns, cinnamon buns, waffles, pastries, breads, etc.

While there has been shown an embodiment in accordance with our invention, it is to be clearly understood that the same may be susceptible to numerous changes apparent to one skilled in the art. Therefore, we do not wish to be limited to the details shown and described but intend to show all changes and modifications that come within the scope of the appended claims.

We claim:

1. A food toaster comprising:
a housing defining a front opening, and, communicating with the opening,
an interior oven chamber,
at least one heater mounted to the housing in the oven chamber to heat food products when they are in the oven chamber, and
a conveyor mounted to the housing and extending at an inclined angle from the front opening into the oven chamber, for conveying one or more food products on the conveyor into the oven chamber.

2. The food toaster of claim 1, wherein the conveyor has a back end in the oven chamber, and the inclined angle is at a degree sufficient to cause the center of gravity of the food product on the conveyor to shift rearward and allow the food product to extend at a length further beyond the back end of the inclined conveyor than if the conveyor were horizontally disposed.

3. The food toaster of claim 1, wherein the inclined angle of the conveyor is from about 5 degrees to about 12 degrees from the horizontal.

4. The food toaster of claim 1, wherein the inclined angle of the conveyor is from about 6 degrees to about 8 degrees from the horizontal.

5. The food toaster of claim 1, wherein the inclined angle of the conveyor is about 7 degrees from the horizontal.

6. The food toaster of claim 2, wherein the oven chamber includes a food product return chute that is mounted to the housing and extends from an interior portion of the oven chamber beyond the back end of the conveyor and under the conveyor to the front opening, the return chute being configured to receive food products that drop off of the back end of the inclined conveyor and return the received food products to the front opening of the housing.

7. The food toaster of claim 6, wherein the inclined conveyor shifts the product center of gravity backwards on the conveyor, increases the rotational moment of the food product over the back end of the conveyor and increases the subsequent food product exit force to propel the food product completely to the front opening of the housing, thereby to avoid a logjam of food products adjacent the front end of the return chute.

8. The food toaster of claim 6, wherein the food products have a top surface, a bottom surface, and a leading portion, and wherein the additional length that the leading portion of the food product extends beyond the back end of the inclined conveyor causes the leading portion of the food product to pivot about the back end of the conveyor and the food product to flip over and land on its top surface on the return chute for passage to the front opening of the housing.

9. The food toaster of claim 1, wherein the housing has a back wall with an upper rear portion, the upper rear portion includes a vent, and the inclined conveyor acts as a chimney to direct hot air from the housing chamber to and through the vent.

10. The food toaster of claim 1, wherein the front opening of the housing is defined in part by a lower lip, and there is included a food collector tray that extends forward away from the lower lip to receive food products that exit the front opening and prevent an accumulation of food products on the return chute just inside the front opening.
